(19) United States
(12) Patent Application Publication
(10) Pub. No.: US 2022/0261662 A1
(43) Pub. Date: Aug. 18, 2022

(54) EXTENSIBLE INFORMATION SYSTEMS AND METHODS

(71) Applicant: VIRGINIA TECH INTELLECTUAL PROPERTIES, INC., Blacksburg, VA (US)

(72) Inventors: Prashant Chandrasekar, Natick, MA (US); Edward A. Fox, Blacksburg, VA (US)

(21) Appl. No.: 17/673,242

(22) Filed: Feb. 16, 2022

Related U.S. Application Data
(60) Provisional application No. 63/149,764, filed on Feb. 16, 2021.

(51) Int. Cl. G06N 5/02; G06F 40/211; G06F 16/901

(52) U.S. Cl. CPC G06N 5/022; G06F 16/9024; G06F 40/211

(57) ABSTRACT

The present disclosure describes various embodiments of extensible information systems and methods. One such system comprises a user interface configured to receive a query that includes a description of a research goal of a user; a reasoner configured to receive data from the user interface related to a user goal and generate a description of a workflow that will address the user goal, based on information in a knowledge graph and a services registry; and a workflow manager configured to receive a workflow description from the reasoner and manage an execution of workflows by scheduling for execution one or more services that are identified in the knowledge graph and described in the services registry. Other systems and methods are also provided.

### CROSS-REFERENCE TO RELATED APPLICATION

This application claims priority to co-pending U.S. provisional application entitled, “METHOD AND SYSTEM FOR ACHIEVING INFORMATION GOALS WITH A REASONER, KNOWLEDGE GRAPH, AND WORKFLOWS,” having Ser. No. 63/149,764, filed Feb. 16, 2021, which is entirely incorporated herein by reference.

### GOVERNMENT LICENSE RIGHTS

This invention was made with government support under Grant Nos. OAC-1835660, CMMI-1638207, and IIS-1619028 awarded by the National Science Foundation, and Grant No. 1R01DA039456-01 awarded by the National Institutes of Health. The government has certain rights in the invention.

### BACKGROUND

Data (as well as information and knowledge) research commonly involves an analysis of an extensive collection of digital content. Without support—such as by a lab, developers, or data analysts/scientists—researchers often undertake the data analysis themselves, using available analytical tools, frameworks, and languages, whereby researchers search information systems, such as the web or digital libraries, learn a new language or framework or tool for their data collection and analytical needs, and spend a great deal of time. Then, in order to extract and produce the information needed to achieve their goals, the researchers will need to know what sequences of functions or algorithms to run using such tools, after considering all of their extensive functionality. Further, as more algorithms are being discovered and datasets are getting larger, the information processing effort becomes more complicated. Given the expectation of using “big data,” and the pace at which newer methods get built, this approach is not scalable.

To aid with these challenges, one hope for data researchers is that they can leverage analytical solutions, frameworks, and workflow-based engines that allow researchers to produce and share their solutions. Some engines and data analysis workflow repositories cater to a particular research domain. The interface for these workflow solutions assumes that the intended user knows how to break down their problem into tasks, and knows what libraries or data mining functions they need to call upon to solve each task. However, it cannot be expected that all data researchers will have this background knowledge. Without such background knowledge, and task-oriented problem solving skills, these tools may not prove to be helpful to the researchers.

### BRIEF DESCRIPTION OF THE DRAWINGS

Many aspects of the present disclosure can be better understood with reference to the drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram of an exemplary extensible information system in accordance with various embodiments of the present disclosure.

FIG. 2 is a diagram of a toy example of a knowledge graph in accordance with various embodiments of the present disclosure.

FIG. 3 is a diagram of exemplary components of an extensible information system that make a workflow-based digital library in accordance with various embodiments of the present disclosure.

FIG. 4 is a flow chart illustrating an exemplary method for extensible management of information in accordance with various embodiments of the present disclosure.

FIG. 5 depicts a schematic block diagram of a computing device that can be used to implement various embodiments of the present disclosure.

### DETAILED DESCRIPTION

The present disclosure describes various embodiments of extensible information systems and methods. Accordingly, the present disclosure presents a class of information systems or digital libraries that capture the solution space to the problem of supporting information needs of users that are researching or exploring a subject of interest, such as data researchers and subject matter experts, among others.

The evolution of workflow management systems (WMSs) has been a natural consequence of advances in computer technology, an increase in digital sensors, and as a by-product, an increase in the volume of observational data and any data collected through automation. There are many more powerful WMSs such as KNIME, Kepler, Galaxy, etc. These WMSs serve as infrastructures that support research in various domains such as earth science, astronomy, chemistry, and geology. The focus of the developers of these WMSs is to provide the resources for conducting their experiments. These systems empower users, such as researchers, to conduct experiments that support up to a million tasks and process petabytes of data, while integrating libraries deployed on various platforms. One of the main aims of these WMSs is to help the users conduct their experiments without having knowledge of workflow execution and optimization. However, the onus is still on the user to create the workflow. Users of these systems are typically provided an interface to search, download, edit, and re-run published workflows. However, these interfaces are not particularly helpful for an audience of users who might have little to no information on the tasks and files required. That knowledge barrier is not addressed by the WMSs mentioned above.

In accordance with embodiments of the present disclosure, a knowledge base is devised to store artifacts, representations to capture associations (goals to tasks, tasks to services), and a processing engine or reasoner to deduce relationships between information goals associated with a research query of a digital library that includes a description of a research goal of a user. Thus, the present disclosure offers a knowledge graph built on the knowledge base of these associations, and a reasoner based on algorithms that leverage the knowledge to produce results that satisfy a user's information needs. When implemented, the knowledge graph will support the generation of a description of a workflow that will address the user goal, based on information in a knowledge graph and a services registry, and will produce desired results when executed by a workflow engine. The workflows represent the functionality of an information system that supports the data needs of users. Herein, the term “workflow” refers to a connected collection of components.

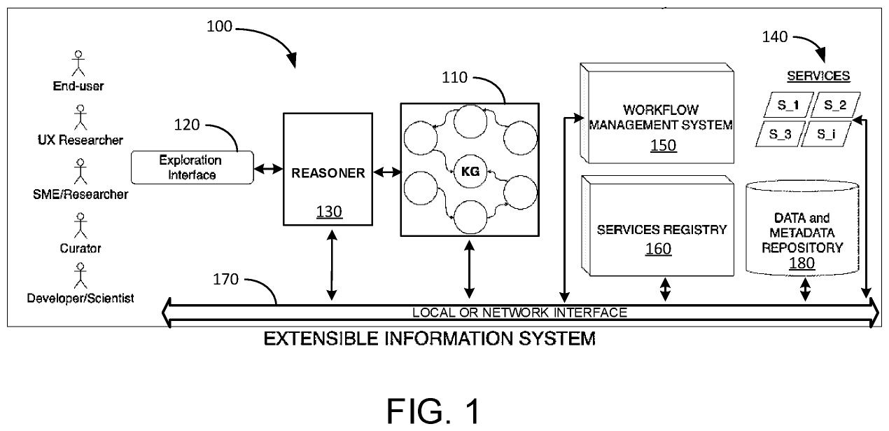

As is shown in FIG. 1, an exemplary embodiment of an extensible information system 100 of the present disclosure includes a knowledge graph (KG) 110 that provides a graph-based representation of artifacts. Accordingly, when a user, such as a subject matter expert (SME) data researcher utilizes an exploration graphical user interface (“exploration interface”) 120, the interface 120 can access a reasoner module 130. The exploration interface 120 may be configured to receive, as input, a data researching interest of the user and to display a workflow related to the data researching interest. Accordingly, the exploration interface 120 may enable the user to specifically request a particular information state or node of the knowledge graph 110 as their information goal, where the reasoner (e.g., processing engine) 130 is configured to generate a workflow description comprising a set of services 140 or transformations from the knowledge graph that will produce the requested information. Alternatively, the reasoner 130 can infer the desired information goal from the original input provided by the user, and not involve the user in identifying that goal. The reasoner 130 can forward information, e.g., including the generated workflow description, to a Workflow Management System (WMS) 150, where the WMS 150 is responsible for orchestrating and executing the workflow, which contains individual services 140. Correspondingly, the workflow management system 150 is coupled to a services registry 160 via a local interface or a network interface 170. The services registry 160 is configured to index and store services built by system developers. In various embodiments, a data repository 180 may also be provided to store a collection of digital content to be searched and/or metadata or other data associated with services and/or goals identified in the knowledge graph 110. The range of information support from this environment can be dynamic and based on the domains of the (a) ever-changing needs of the researchers, (b) the advances in models/algorithms deployed as services by the developers, and (c) the type and quality of digital content created by curators. Thus, users of the extensible information system 100 can include, as shown in FIG. 1, personas associated with categories of users including end-user, UX researcher, SME/researcher, curator, developer, and scientist. Such users can ensure that the system is indeed extensible, by adding to or enhancing each of the components of that system. In various embodiments, system components (e.g., interface 120, reasoner 130, KG 110, WMS 150, etc.) can be part of a single computer system or part of multiple computer systems, such as a distributed computing system or systems that are coupled via a network connection, via a local or network interface 170.

Correspondingly, systems and methods of the present disclosure are enabled to obtain one or more information goals of a data researcher, via the exploration interface 120 and reasoner 130, and to break down or identify a sequence of tasks or various sequences of tasks that are able to achieve the stated goal using the knowledge graph 110, where the tasks are supported by a set of services 140 (as cataloged by a service registry 160). After selecting a particular sequence of tasks (via the user using the exploration interface 120 or the reasoner 130 by following predefined rules), the selected workflow or sequence of tasks (associated with the workflow description) is provided to a workflow manager 150 for execution.

In general, the present disclosure relates to considerations of digital libraries, but it can be generalized to a broad range of types of information systems. Although to many the scope of “information discovery” is confined to digital content external to an information system, i.e., that it manages, the present disclosure considers an even broader scope, where the system itself—including artifacts that guide its construction, and its various services, service integrations, data, knowledge, and components—can be explored and extended.

To be able to support the knowledge base that captures and stores artifacts/information and maintains the various associations (goals to tasks, tasks to services) used in selecting a workflow to service a research query, knowledge graphs 110 are featured in an exemplary extensible information system and method. The research query can be as simple as a single word that might be sent to a WWW search engine, where the implicit understanding is that webpages related to that word are to be returned, or as complex as a statement using any of the many query systems that are used to access or manage data or information or knowledge.

For example, in various embodiments, an exploration interface 120 can be configured to show a user, such as a data researcher, a knowledge graph 110 where the nodes represent the end “state” of information that the researcher has indicated that they want to acquire and the relationship between the nodes represents events/operations that can be taken to reach the stated goal of the researcher. Thus, a workflow can be defined as a sequence of events/operations that changes the state of information, and from the researcher's point-of-view, all they need to do is select the node representing their interest/goal from the knowledge graph 110. Under the hood, the selected node and its relationships allows for a reasoner 130 to generate a set of paths that represent data analysis-based workflows. To do so, the reasoner 130 can compile associations and deduce relationships between information goals as well as intermediate states of information. The generated workflow paths may then be executed (by a workflow management system 150) and the output information requested by the data researcher can be provided via the exploration interface 120. The representation of the knowledge (using a knowledge graph) eliminates the need for the user (e.g., data researcher) to know the details of the underlying operations. The generated workflow when executed will produce the requested information, since workflows are configured for information goals.

Additionally, data analysis workflows can be represented of any form, eliminating the need for an additional knowledge base and a middle layer to translate user queries to workflows. An exemplary knowledge graph 110 of the present disclosure can capture and represent both the user information needs and workflows together, such that the scope of information supported by the knowledge graph 110 is flexible and is dependent on the research community.

In various embodiments, a hypergraph-based knowledge graph is used to model the researcher goals and workflows. As such, the hypergraph-based knowledge graph is able to represent task precedence or data dependency AND multiple paths to a particular information/node state. In particular, a hypergraph allows for the specification of n-ary relations or “hyperedges” within a graph, which allows for representation of multiple data dependencies of a task with just one (hyper)edge. As a result, in the knowledge graph, every edge incident to a node of data researching interest represents a different path (or workflow) to achieve that state of information. It would be very cumbersome to capture this relationship using only traditional “binary” edges.

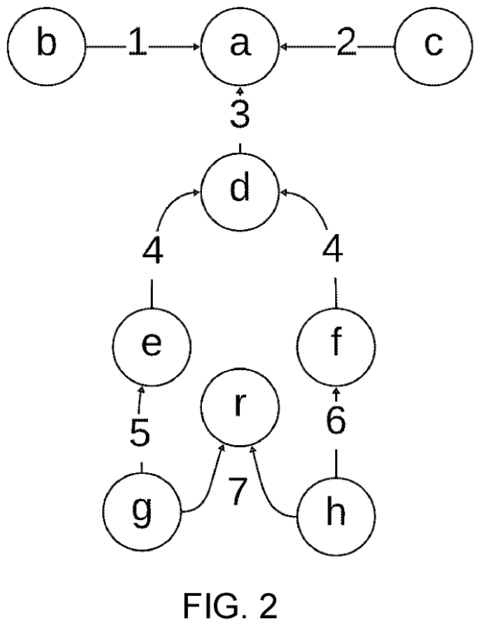

Let us consider a toy example as shown in FIG. 2. This is a graph representation of information goals / states of information (shown as alphabets) connected to one another by services (shown as numbers). From this representation, we can observe that there are three different workflows to derive information goal “a”. All three workflows can derive that information goal. Based on the input provided, a workflow can be selected. With this representation of the hypergraph, the information goals/nodes related to the data researching interest of a user is presented along with a set of paths representing workflows which can deliver the requested information.

Let us say the user (e.g., data searcher) wants the information goal “a”. There are three possible workflows, broken down as: (1) a=Service 1; (2) a=Service 2; or (3) a=Service 3+Service 4+Service 5+Service 6. When these workflows, or sequences of services, are executed by a workflow engine of the WMS 150, the generated information can be outputted to the user. Similarly constructed workflows can also be generated for any of the goals (e.g., nodes) in the knowledge graph. To generate a sequence, we recursively go “up” the graph starting with the node representing the information requested by the user. The recursion continues until we reach nodes with no parent. Since there are three hyperedges incident to the information goal “a”, there are three possible “paths” one could take, and therefore three different workflow sequences (as indicated above). This process of generating a workflow is similar to the recursive replacement traversal of a context-free grammar (CFG) for generating sentences, where a context-free grammar is a type of formal grammar that consists of a set of rules known as “production rules.” The production rules can be used to generate and describe patterns of strings in a context-free language. As such, in various embodiments, knowledge graphs can be represented using a CFG of an extensible information system of the present disclosure.

In accordance with the present disclosure, an exemplary extensible information system and related methods operate on the concept of an information state and the transition from one state to the next. An “input” to the extensible information system/method is a goal, which is a state of information desired by a user (e.g., data researcher). The workflow generated or “output” of the information system represents a sequence of transition events or operations. The system components that facilitate this type of information exploration include the knowledge graph 110 that serves as a knowledge base that maintains the relationships between information states; the services registry 160 that stores the list of operations or transition events; and the reasoner 130 that analyzes the “conditions” wherein the operations or events, stored in the registry 160, are to operate on the states of the knowledge graph 110 and return a workflow representing a sequence of such events.

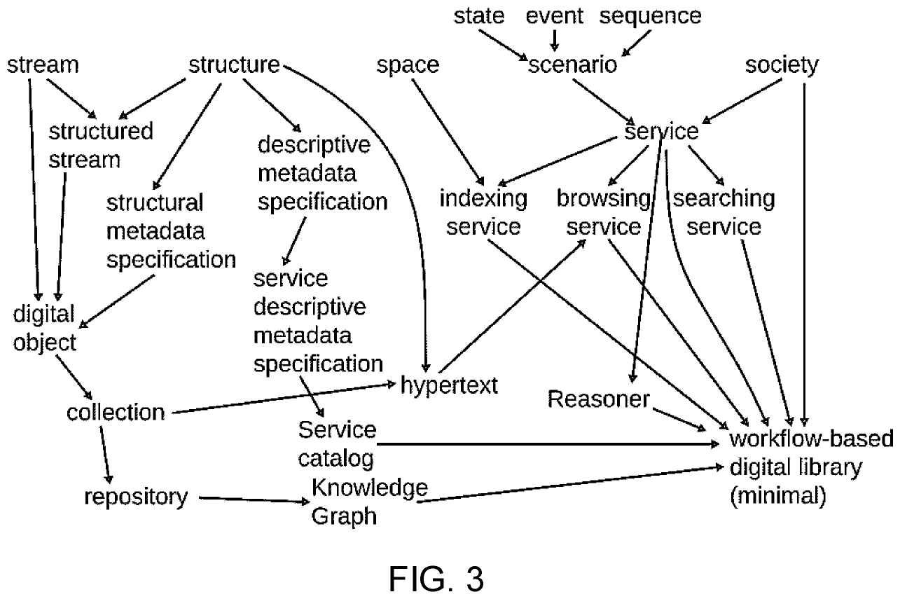

FIG. 3 showcases the components of the extensible information system that, together, make a workflow-based digital library, in accordance with various embodiments of the present disclosure. Formal definitions of particular constructs of the digital library (DL) are provided as follows, where the definitions for the components for the workflow-based digital library are derived from the following definitions (found in Edward A. Fox, Marcos André Gonsalves, and Rao Shen. “Theoretical Foundations for Digital Libraries: The 5S (Societies, Scenarios, Spaces, Structures, Streams) Approach,” Synthesis Lectures on Information Concepts, Retrieval, and Services, Morgan & Claypool Publishers (2012)):
State: A state is a function, from labels L to values V. A state set S consists of a set of state functions s: L→V.
Transition Event: A transition event (or simply event) on a state set S is an element e=(sᵢ, sᵢ)∈(S×S) of a binary relation on state set S that signifies the transition from one state to another.
Scenario: A scenario is a sequence of related transition events <e₁, e₂, . . . , eₙ>on state set S such that eₖ=(sₖ, s₍ₖ₊₁₎) for 1≤k≤n.
Service: A service, activity, task, or procedure is a set of scenarios. In an exemplary system, a service is defined for a set of scenarios of size 1.
Descriptive Metadata Specification: Let L=∪Dₖ be a set of literals defined as the union of domains Dₖ of simple datatypes (e.g., strings, numbers, dates, etc.). Let also R and P represent sets of labels for resources and properties, respectively. A descriptive metadata specification is a structure (G,R∪L∪P,F), where:
   (a) F: (V∪E)→(R∪L∪P) can assign general labels R∪P and literals from L to nodes of the graph structure;
   (b) for each directed edge e=(vᵢ, vⱼ) of G, F(vᵢ)∈R∪L; F(vⱼ)∈R∪L and F(e)∈P;
   (c) F(vₖ)∈L if and only if node vₖ has outdegree 0.
Metadata Catalog: Let C be a collection (which is a set of digital objects) with k handles in H. A metadata catalog DM_{C} for C is a set of pairs {(h,{dm₁, . . . , dmₖₕ})}, where h∈H and the dm; are descriptive metadata specifications.
Service Specification: A Service Specification is a descriptive metadata specification for Services. A Service Specification is a structure (G, R∪L∪P, F), where:
   (a) R represents sets of labels for resources;
   (b) L=uDₖ represents a set of literals defined as the union of domains of simple data types (e.g., strings, numbers, dates, etc.);
   (c) for each directed edge e=(vᵢ, vⱼ) of G, F(vᵢ)∈R∪L; F(vⱼ)∈R∪L and F(e)∈P∈{‘name’, ‘precondition’, ‘postcondition’, ‘APIEndpoint’}
Here F(e)={‘precondition’, ‘postcondition’}, F(vⱼ) E informationstate, s∈2^{Q}, where Q=finite set of state functions with domain on digital objects and range either of True or False. Also F(e)={‘name’, ‘APIEndpoint’}, F(vⱼ)∈L.
Service Catalog/Registry: Let C be a collection of Services with k handles in H. A Service Catalog or Registry for the collection C is a set of pairs (h, dm₁, dm₂, . . . , dmᵢ, . . . ), where h∈H and each dmᵢ is a descriptive service specification.
Knowledge Graph: A Knowledge Graph is a repository with a graph structure G=(V, E), where: (a) V∈2^{Q}, Q=finite set of state functions; (b) E is an edge between (vᵢ, vⱼ), where vᵢ, vⱼ∈V if there exists a Service with handle, hᵢ, with a precondition state set, u, such that u⊂vᵢ and with a postcondition state set, u, such that u⊂vⱼ.
Reasoner: A Reasoner is a service that takes as input a Planning instance, Π, and produces a workflow, w, that is a solution that achieves a goal state, g, where:
   (a) A planning instance or a planning problem is represented by a tuple Π=(KG, i, g), in which KG=the knowledge graph, which specifies the domain knowledge; i⊂2^{Q} is the initial state specification; and g⊂2^{Q} is the goal state. Here Q=finite set of state functions; and
   (b) A workflow is a sequence of Services w=<s₁, s₂, . . . , sₙ> which, when executed by a workflow engine, transform from the initial state to achieve the goal.
Workflow-based Digital Library: A Workflow-based Digital Library is a tuple (WDL)=(SC, KG, Reasoner, Serv, Soc), where:
   (a) Reasoner (RE) is a service in the WDL that generates a workflow;
   (b) Service Catalog (SC) is a catalog of workflow services;
   (c) Knowledge Graph (KG) is a graph-based repository of information states;
   (d) Serv is a set of services containing at least indexing, searching, and browsing; and
   (e) Soc=(SM∪A_{c}, R), where SM is a set of service managers responsible for running DL services, Ac⊂{SMEs, Developers, UX Researchers, General Users} are a set of actors that use those services, and R is a set of relationships among SM∪A_{c}.

Then, as an illustrative case study, let's consider a workflow-based digital library looking to support societies interested in the goal of collecting and mining Internet social posts in regard to a certain event, such as Twitter posts about the event. To describe a Twitter-centric workflow-based DL (TWDL), we can formally describe information in Twitter as a “Twitter Heterogeneous Information Network” because “Twitter data contains heterogeneous entities and multiple types of relationships” using the work of Liang Zhao, et al. See Liang Zhao, Feng Chen, Jing Dai, Ting Hua, Chang-Tien Lu, and Naren Ramakrishnan, “Unsupervised Spatial Event Detection in Targeted Domains with Applications to Civil Unrest Modeling,” PloS one, 9:e110206, 10 (2014).

Accordingly, a Twitter heterogeneous information network can be defined as an undirected graph G=(V, E, W, S), where V=T∪F. T refers to a set of tweet nodes, and F=F₁ . . . F_{M} refers to M other types (e.g., term, user, and hashtag) of nodes, called feature nodes. E⊂V×V represents the set of edges, which are all undirected. W denotes the set of weights of nodes and edges. S={l(v)|v∈T } refers to a set of geographic locations of tweet nodes, where l(v)∈R² represents a tuple consisting of the latitude and longitude of tweet node v. Each of the undirected edges in E describes a relationship between tweet nodes and feature/tweet nodes. For instance, a tweet node could be a “reply” to another tweet node. Similarly, a user node (which is a feature node) would have an “authorship” relationship with the tweet node. As mentioned above, a Twitter-centric workflow-based DL (TWDL) is a workflow-based DL that operates in the domain of the Twitter Heterogeneous Information Network (THIN). Therefore, it can be defined as such. The formal definition of TWDL has the following criteria/constraints on the definitions used to define a workflow-based DL:
State Functions: A state set in a digital library is defined as a set of functions that operate on digital objects. The functions in a TWDL operate on “statements.” Statements are triples (source node, edge, target node) representing the edge relationship between tweet nodes and/or feature nodes from Twitter Heterogeneous Information Network (THIN). The range of values for these functions remain the same as the case for WDL.
States: Given a finite set of edges/functions, Q, representing THIN, a state s (as defined for WDL) is ∈2^{Q}. This state is a sub-graph or “sub-THIN”.

Accordingly, we can define the digital objects for TWDL from this information, where the set of services for TWDL is constrained by services that operate on THIN. These include, but are not limited to, services that perform network generation/mining and image and text mining. The contents of the knowledge graph and the service catalog are based on THIN-centric digital objects and services. Regarding the formal description of a minimal TWDL, we can borrow the descriptions of the knowledge graph, reasoner, and service catalog from WDL. To similarly describe a workflow-based digital library for other digital content, such as electronic theses and dissertations (ETDs) and web pages, we can follow the same process by defining the digital object formally and then identifying the different state functions that operate on the ETD- or web page-based digital objects, which allow us to build components of the information system or digital library specific to them.

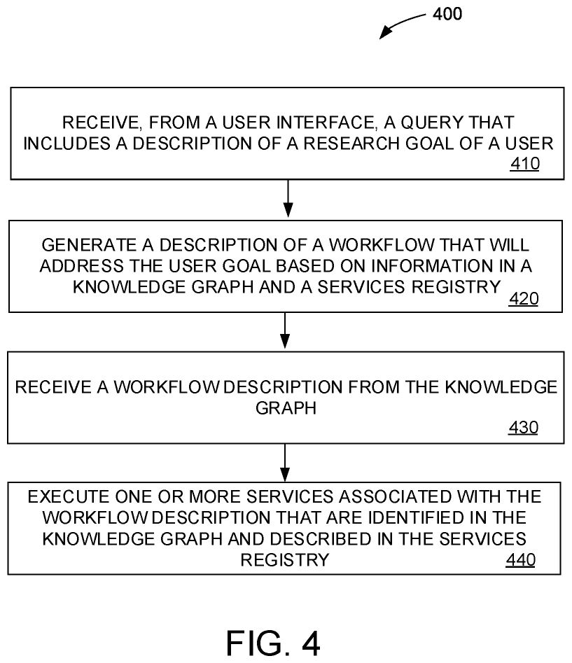

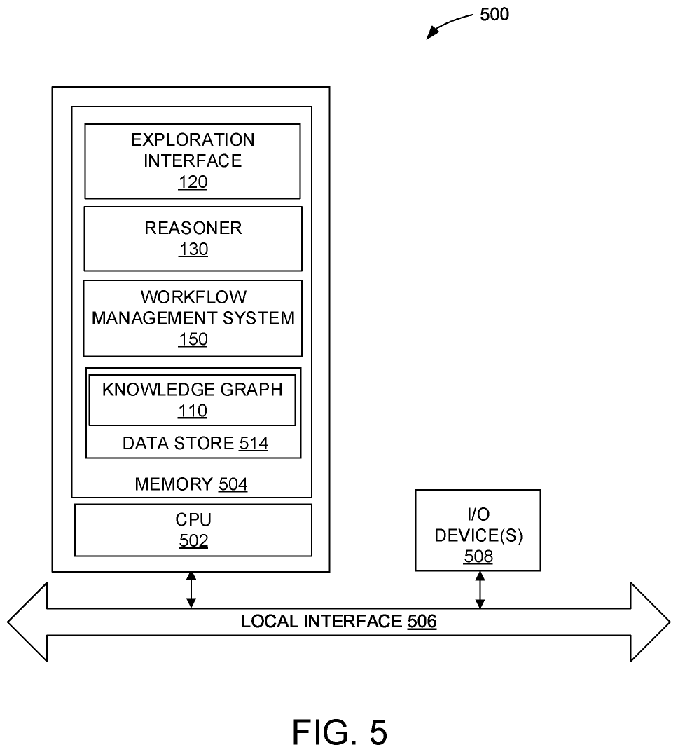

FIG. 4 is a flow chart illustrating an exemplary method 400 that may be implemented by an extensible information system 100 described with reference to FIG. 1 and a computing device 500 of FIG. 5. The flow chart is related to a method for extensible management of information. In block 410, the computing device may receive, from a user interface 120 of one or more computing devices 500, a query that includes a description of a research goal of a user. Next, in block 420, the computing device 500 may generate a description of a workflow that will address the user goal based on information in a knowledge graph 110 and a services registry 160. Accordingly, in block 430, the computing device may receive a workflow description from the knowledge graph 110 and execute one or more services associated with the workflow description that are identified in the knowledge graph and described in the services registry, as stated in block 440.

In various embodiments, system components (e.g., interface 120, reasoner 130, KG 110, WMS 150, etc.) can be part of a single computer system or part of multiple computer systems, such as a distributed computing system or systems that are coupled via a local or network interface 170 with other system components. Accordingly, FIG. 5 provides a schematic of a computing device 500 that can be used to implement various embodiments of the present disclosure. An exemplary computing device 500 includes at least one processor circuit, for example, having a processor (CPU) 502 and a memory 504, both of which are coupled to a local interface 506, and one or more input and output (I/O) devices 508. The local interface 506 may comprise, for example, a data bus with an accompanying address/control bus or other bus structure as can be appreciated.

Stored in the memory 504 are both data and several components that are executable by the processor 502. In particular, stored in the memory 504 and executable by the processor 502 of computing device 500 and/or across multiple computing devices are an exploration graphical user interface (“exploration interface”) 120, a reasoner application or module 130, and/or a workflow management system 150, in accordance with embodiments of the present disclosure. Also stored in the memory 504 may be a data store 514, and/or other data. One or more data stores 514 of computing device 500 and/or multiple computing devices can include a database of knowledge graphs 110 services 140, services registry 160, and/or data repository 180, and potentially other data. In addition, an operating system may be stored in the memory 504 and executable by the processor 502. The I/O devices 508 may include input devices, for example but not limited to, a keyboard, mouse, etc. Furthermore, the I/O devices 508 may also include output devices, for example but not limited to, a printer, display, etc. Also, the I/O devices 508 may include a communication component, such as a network adapter or interface (e.g., WiFi network adapter, Bluetooth adapter, 4G wireless adapter, ethernet adapter, etc.), that allows for wired or wireless communications with external devices and networks.

As an illustrative example, an exemplary exploration interface 120 provides a user with the option of browsing or searching digital collection(s) that are indexed (e.g., in ElasticSearch) as well the option of request information goal(s) as a query. Completion of the second option can trigger workflow generation using a knowledge graph 110 and execution of the workflow via a workflow management system 150 (e.g., via Apache Airflow). Thus, requests can be routed and served according to a knowledge graph 110 that determines the sequence of services to execute to satisfy the user requirements. Accordingly, the workflow management system 150 can execute a service that supports a task identified by a system developer in a sequence, such that information processed from one service can be passed to a next service. The inputs to the workflow and the outputs from the workflow executions can all be transacted via the exploration interface 120, in various embodiments. Further, in various embodiments, curators can add and manage data collections through the user interface as well. In some embodiments, developers may also use the interface to add and manage the services that they are building.

Certain embodiments of the present disclosure can be implemented in hardware, software, firmware, or a combination thereof. If implemented in software, logic or functionality for an exemplary extensible information system are implemented in software or firmware that is stored in a memory and that is executed by a suitable instruction execution system. If implemented in hardware, logic or functionality for the extensible information system and related components can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, at least the following is claimed:

1. A system for extensible management of information comprising:
a user interface configured to receive a query that includes a description of a research goal of a user;
a reasoner configured to receive data from the user interface related to a user goal and generate a description of a workflow that will address the user goal, based on information in a knowledge graph and a services registry; and
a workflow manager configured to receive a workflow description from the reasoner and manage an execution of workflows by scheduling for execution one or more services that are identified in the knowledge graph and described in the services registry.

2. The system of claim 1, further comprising the knowledge graph used by the reasoner, wherein the knowledge graph comprises nodes representing research goals and edges that indicate relationships among the research goals and services performed to achieve the research goals.

3. The system of claim 1, further comprising the services registry that has descriptions of services that are identified in the knowledge graph.

4. The system of claim 1, wherein the knowledge graph is represented as a hypergraph.

5. The system of claim 4, wherein the knowledge graph is formatted using a context-free-gram mar.

6. The system of claim 1, wherein the user interface supports queries for exploration of a digital library, additions to the knowledge graph and services registry, and content curation.

7. The system as in claim 1, wherein the user interface is configured to provide a user with a choice among workflows that address the research goal, wherein the reasoner is configured to perform the choice selected by the user.

8. The system as in claim 1, wherein the reasoner automatically selects a preferred workflow to address the research goal.

9. A method for extensible management of information comprising:
receiving, from a user interface of one or more computing devices, a query that includes a description of a research goal of a user;
generating, by the one or more computing devices, a description of a workflow that will address the user goal, based on information in a knowledge graph and a services registry; and
receiving, by the one or more computing devices, a workflow description from the knowledge graph; and
executing, by the one or more computing devices, one or more services associated with the workflow description that are identified in the knowledge graph and described in the services registry.

10. The method of claim 9, wherein the knowledge graph is represented as a hypergraph.

11. The method of claim 10, wherein the knowledge graph comprises nodes representing research goals and edges that indicate relationships among the research goals and services performed to achieve the research goals.

12. The method of claim 9, wherein the user interface supports queries for exploration of a digital library, additions to the knowledge graph and services registry, and content curation.

13. The method of claim 9, wherein the user interface is configured to provide a user with a choice among workflows that address the research goal, wherein the one or more computing devices are configured to perform the choice selected by the user.

14. The method of claim 9, wherein the computing device automatically selects a preferred workflow to address the research goal.

15. A computer-readable non-transitory media storing instructions that, when executed by one or more processors of a computing device, cause the computing device to perform operations comprising:
receiving, from a user interface, a query that includes a description of a research goal of a user;
generating a description of a workflow that will address the user goal, based on information in a knowledge graph and a services registry; and
receiving a workflow description from the knowledge graph; and
executing one or more services associated with the workflow description that are identified in the knowledge graph and described in the services registry.

16. The computer-readable non-transitory media of claim 15, wherein the knowledge graph is represented as a hypergraph.

17. The computer-readable non-transitory media of claim 16, wherein the knowledge graph comprises nodes representing research goals and edges that indicate relationships among the research goals and services performed to achieve the research goals.

18. The computer-readable non-transitory media of claim 15, wherein the user interface supports queries for exploration of a digital library, additions to the knowledge graph and services registry, and content curation.

19. The computer-readable non-transitory media of claim 15, wherein the user interface is configured to provide a user with a choice among workflows that address the research goal, wherein the operations further comprise performing the choice selected by the user.

20. The computer-readable non-transitory media of claim 15, wherein the operations further comprise automatically selecting a preferred workflow to address the research goal.
